(19) United States
(12) Patent Application Publication
(10) Pub. No.: US 2008/0164806 A1
(43) Pub. Date: Jul. 10, 2008

(54) Triple wavelength white light LED with high color saturation

(76) Inventor: Hsing Chen, Kukou Township (TW)

Correspondence Address: PRO-TECHTOR INTERNATIONAL SERVICES, 20775 NORADA CT., SARATOGA, CA, 95070, US

(21) Appl. No.: 11/786,902

(22) Filed: Apr. 12, 2007

(30) Foreign Application Priority Data
Jan. 5, 2007 (TW) 096100744

(51) Int. Cl. H01J 1/62

(52) U.S. Cl. 313/503

(57) ABSTRACT

The present invention provides a white light emitting diode (LED) is applied to colorful LCD as backlight source with high color saturation. It is different from traditional two-wavelength type white light LED that is coated a blue LED chip with yellow phosphor and only provides 50˜60% NTSC. In this invention, white light LED generates three-wavelength by coating a blue LED chip with green and red phosphors. It can provide more than 80% NTSC and is suitable for backlight of LCD TV and computer monitor.

### BACKGROUND OF THE INVENTION

1. Field of the Invention

The present invention relates to white light emitting diode (LED) is applied for liquid crystal display as backlight source with high color saturation.

2. Description of the Related Art

Traditionally, white light emitting diode is made by coating yellow phosphor on a blue LED chip to generate two-wavelength type white light LED. The major companies having two-wavelength type white light LED are Nichia using YAG as yellow fluorescence powder, OSRAM by TAG as yellow phosphor and Toyota-Gosei using silicates as yellow phosphor.

The two-wavelength type white LED has some weaknesses including lower color rendering index (CRI) about 70%, poor color saturation about 50˜60% . . . etc. Some companies focus on high color rendering index to develop white light LED for the lighting market. But high CRI white light LED for lighting always has poorer NTSC characteristic in LCD backlight application. In other words, the higher CRI has the poorer NTSC, and vice versa. Both properties of high color saturation and high CRI are difficult to coexist on one white light LED. For the time being, there are many industry researches for high CRI white light LED in lighting. But few researches for white light LED with high color saturation for LCD application.

A tri-wavelength white means it contains Red, Green, and Blue three waves. And when we say a tri-wavelength white LED with high CRI, or with high NTSC. What's the difference between CRI and NTSC? The major difference is the wave spectrum. The spectrum of high CRI is indiscrete (more like sunlight spectrum), and that of high NTSC is discrete (more like three separate red, green and blue wave peaks). Recently, some researches red chip, green chip and blue chip (i.e. R.G.B) to mix up to make a white light LED for backlight source. Its color saturation is higher than 100%. Some experiments applied to 32″, 37″ and 40″ LCD backlight. Those R.G.B three-chip LED replace CCFL (cold cathode fluorescence lamp) perform more nice color.

However, the difficulty using R.G.B three-chip white light LED as backlight source is how to keep the balance of the luminosities of those three red, green and blue chips to make the white light. Furthermore, it is even harder to maintain the white balance with R.G.B chips' different aging rates in long time. Besides, it is quite expensive making LED light source in this way. To overcome the above mentioned shortcomings, my invention is a “three-wavelength type white light LED in one single-chip with high NTSC”.

### SUMMARY OF THE INVENTION

This invention “triple wavelength white light LED applied to LCD backlight source”. The wavelengths of the R.G.B three-color peaks are designed to fit the color filter of the LCD. Generally, wavelength of blue light is 450˜460 nm, wavelength of green light is 520˜530 nm, and wavelength of red light is 615˜650 nm.

First of all, the blue LED chip with wavelength 450˜460 nm is selected to excite green and red fluorescence phosphors to generate green light and red light and all together with the blue light from LED chip to make the white light. Only the narrow full width half maximum (FW) of green and red light could achieve high NTSC. But it is very difficult to find right phosphors exited by 450˜460 nm to generate narrow FWHM green and red peak, and with long lifetime stabilities. By the present inventor's patient research and development, a kind of three-wavelength type white light LED applied to LCD backlight source is succeeded. LCD can reach more than 80% NTSC by using white light LED of this invention.

### BRIEF DESCRIPTION OF THE DRAWINGS

FIG. 1 is the spectrum of known two-wavelength type white light LED.

FIG. 2 is the excitation and emission spectrogram of red phosphor of the present invention.

FIG. 3 is the excitation and emission spectrogram of green phosphor of the present invention.

FIG. 4 is the spectrogram of proper combination green light exciting from green phosphor and red light exciting from red phosphor and excitation light source, blue light with wavelength 455 nm.

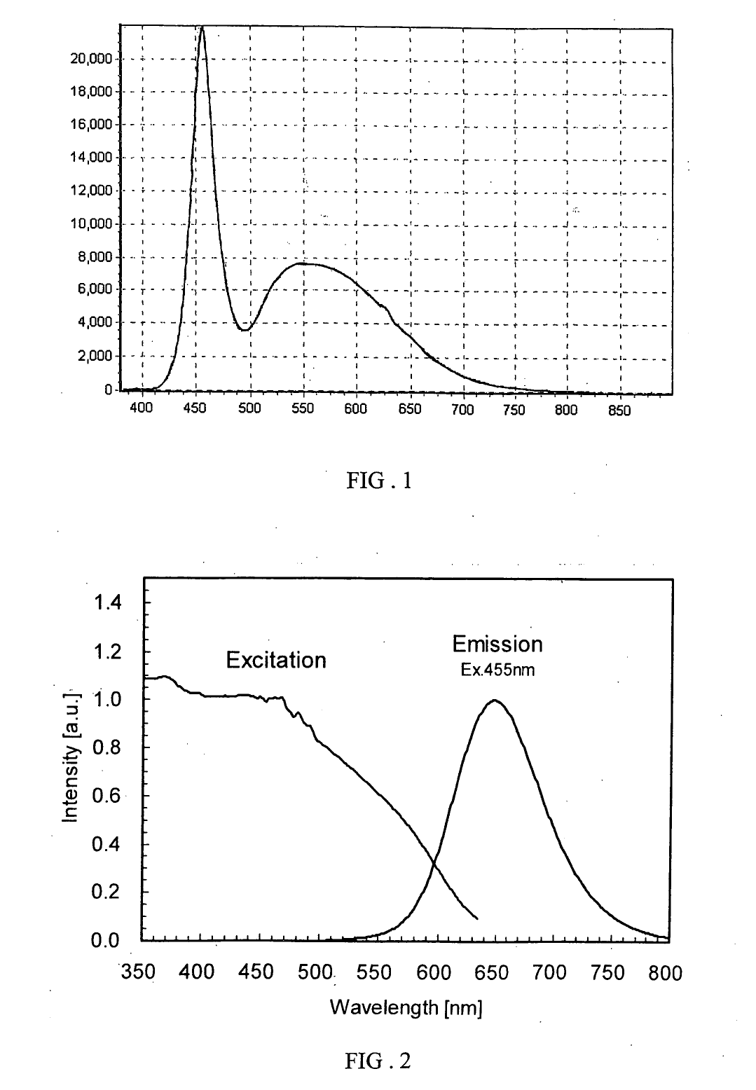

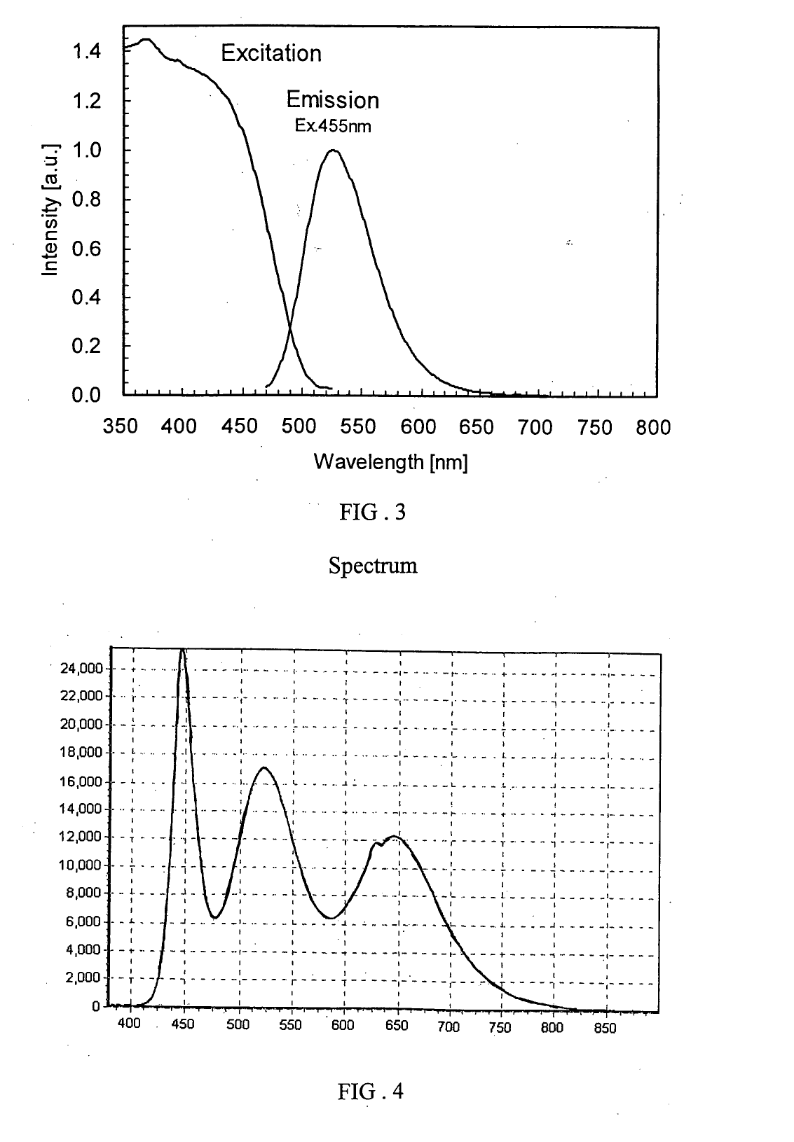

### DETAILED DESCRIPTION OF THE INVENTION

Selected green fluorescence powder is silicate phosphor (Ba₁₋ₓSrₓ)SiO₄:Eu, its FWHM is around 60 nm. Normally, silicate phosphor, (Ba₁₋ₓSrₓ)SiO₄:Eu, is yellow powder having about 80 nm FWHM. But when x≦0.5, the Sr content of silicate phosphor is getting small, the wavelength will be shorter than before and become a high intensity green light with more narrow FWHM. In the case of x=0.15, the chemical composition is (Sr_{0.15}Ba_{0.85})SiO₄:Eu⁺² having pure green peak with wavelength 520 nm and FWHM 60 nm.

Selected red fluorescence powder is nitride phosphor CaAlSiN₃:Eu, it can be excited by blue light to generate red light with wavelength 630 nm and FWHM 60 nm. Also it is so far most efficient and stable red nitride phosphor found.

Since luminescence efficiency of green phosphor and red phosphor do not accord in excitation light of wavelength 450˜460 nm, both of two phosphors must be mixed with proper ratio to meet the requirements of white light LED.

In this invention, mixing green phosphor, (Sr_{0.15}Ba_{0.85})SiO₄:Eu⁺², with red phosphor, CaAlSiN₃:Eu, as weight ratio 2:8 to become mixture of phosphors A. Then blend mixture of phosphors A (15%) with silicone (85%) to become silicone mixture B. Covering blue LED chip with silicone mixture B by dispensing or coating method. After annealing, LED light test is proceed. The results show that mixing light is bluish white light. Its location is x=0.285, y=0.285 at Chromaticity Coordinate. The spectrogram is as shown in FIG. 4. Setting up this triple-wavelength white light LED in LCD backlight module and measuring practical color saturation. It can reach more than 80% NTSC.

Due to white light LED applied to LCD is affected by various structure of LCD panel. General customers' requirements of white light LED are not right white light area, x=0.3˜0.32, y=0.29˜0.33 at Chromaticity coordinates, but bluish white light area. The bluish white area, x is about 0.28±0.02, and y is about 0.28±0.02 at Chromaticity coordinates. That is to say the range of x is 0.26˜0.30, and y is 0.26˜0.30. They depend on the requirements of various structures of LCD and customers.

The present invention adjusts the ratio of phosphors, the concentration of silicone mixture (silicone with phosphors) and the amount of silicone mixtures by dispensing or coating to meet requirement of various Chromaticity coordinates.

A triple wavelength white light LED with high NTSC applied to LCD backlight source must have higher wave crest, lower wave trough and narrower FWHM. The most of patents of traditional tri-wavelength white LED are invented and designed for lighting. In those cases, the patents emphasize that white light LED with high CRI must have higher wave trough and indiscrete light like sunlight spectrum. The properties of white light LED applied for LCD backlight source are just opposite to for lighting. If white light LED with high CRI is applied for backlight source. It will show poor NTSC and color. Therefore, the present invention creates a triple wavelength white light LED that is applied for LCD backlight source. It can replace current two-wavelength type white light LED and R.G.B three-chip white light LED to reduce manufacturing cost.

What is claimed is:

1. A triple wavelength white light LED with high color saturation comprising;
a blue LED chip, a red fluorescence powder, CaAlSi₃N₃:Eu, and a green fluorescence powder, (Ba,Sr)SiO₄:Eu, wherein the fabricating method of white light LED includes following steps;
first step, mixing the green phosphor with the red phosphor as weight ratio 2:8 to become phosphor mixture;
second step, blending 15˜20% the phosphor mixture of first step with 85˜80% silicone to become silicone mixture;
third step, covering the blue LED chip with the silicone mixture of second step by dispensing or coating method, after annealing, the white light LED is finished;
By emitting the blue light of LED chip to excite green and red fluorescence phosphors to generate green light and red light, combining the green light and the red light from phosphors with blue light from LED chip to make the bluish white light with high color saturation for LCD.

2. The white light LED according to claim 1, wherein the blue LED chip emits a blue light with wavelength between 450 nm and 460 nm.

3. The white light LED as according to claim 1, wherein the bluish white light area at Chromaticity is x=0.25˜0.30, y=0.25˜0.30, and the ratio of silicone mixture in second step is 2:8, that is 20% of phosphor mixture in first step and 80% of silicone.
